(19) United States
(12) Patent Application Publication
(10) Pub. No.: US 2008/0228308 A1
(43) Pub. Date: Sep. 18, 2008

(54) CRITICAL DIMENSION UNIFORMITY OPTIMIZATION

(75) Inventor: Howell R. Phelps, Austin, TX (US)

Correspondence Address: DLA PIPER US LLP, P. O. BOX 9271, RESTON, VA, 20195, US

(73) Assignee: TOKYO ELECTRON LIMITED, TOKYO (JP)

(21) Appl. No.: 11/685,570

(22) Filed: Mar. 13, 2007

(51) Int. Cl. G06F 19/00

(52) U.S. Cl. 700/121

(57) ABSTRACT

Embodiments of an apparatus and methods for providing critical dimensions of a pattern. Pattern parameters and process history from a first substrate are used to create a thermal modes. The thermal mode is employed to established intelligent set points for zones of a substrate heater. A second substrate is position proximate the heater. The actual temperature of each zone is controlled using the corresponding intelligent setpoint.

### FIELD OF THE INVENTION

The field of invention relates generally to the fields of semiconductor device and microelectromechanical system manufacturing and, more specifically but not exclusively, relates to the optimization of critical dimension uniformity.

### BACKGROUND INFORMATION

Circuit feature patterns used in the manufacture of a semiconductor device, a liquid crystal display (LCD) or a microelectromechanical device are partially derived from a series of deposition, photolithography, etching, and cleaning processes on a wafer or substrate. Process information may be gathered and stored for each wafer processed, identifying the process history of each wafer. The process history may contain process recipe, tool and chamber identification, a time history, in-line parametric data, or defectivity maps, or other information specific to the manufacturing steps used to create the semiconductor device, LCD or microelectromechanical device. The process history can include information for all or any portion of the processes to which each wafer is subjected. The process history may be stored for a given time to allow, for example, production and technical personnel to identify sources of variability or other problems in the manufacturing process. Process tools and chambers may be scheduled in a feed-forward manner to provide a wafer or substrate a planned path for processing depending on the specific design requirements of the circuit feature.

Post exposure bake (PEB), a heat-treating sub-process in the photolithography process, may play a role in establishing circuit feature characteristics. Thermally treating a resist with a hotplate in a thermal or coating developing system may have many purposes, from removing a solvent to activating a chemically amplified resist (CAR).

Chemically amplified resists were developed because of the low spectral energy of DUV radiation. A CAR comprises one or more components, such as chemical protectors, that are insoluble in the developer and other components, such as a photoacid generator (PAG). During an exposure step, the PAGs produce acid molecules that include the image information. The acid molecules may remain inactive until a PEB is performed. The PEB drives a deprotection reaction forward in which the thermal energy causes the acid to react with the chemical protectors.

### BRIEF DESCRIPTION OF THE DRAWINGS

The present invention is illustrated by way of example and not as a limitation in the figures of the accompanying drawings, in which

FIG. 1 is a schematic diagram of a coating/developing system;

FIG. 2 is a perspective plan view of a single heat treatment apparatus of FIG. 1;

FIG. 3 is a diagrammatic view of a hotplate of the heat treatment apparatus in accordance with an embodiment of the invention;

FIG. 4 is a diagrammatic view of a hotplate in accordance with an embodiment of the invention;

FIG. 5 is a diagrammatic view of a hotplate in accordance with another embodiment of the invention;

FIG. 6 is a diagrammatic view of a hotplate in accordance with an alternative embodiment of the invention;

FIG. 7 is a diagrammatic representation of a thermal processing system including multivariable control in accordance with an embodiment of the invention;

FIG. 8 is a simplified block diagram for a multi-input/multi-output (MIMO) system in accordance with an embodiment of the invention;

FIG. 9 is a simplified block diagram of a thermal processing system including an intelligent setpoint controller in accordance with an embodiment of the invention;

FIG. 10 is a schematic representation of a thermal processing system including a virtual sensor in accordance with an embodiment of the invention.

FIG. 11 is a schematic representation of a model of a thermal processing system in accordance with an embodiment of the invention;

FIG. 12 is a simplified diagrammatic view of an instrumented substrate in accordance with an embodiment of the invention; and

FIG. 13 is a flowchart describing one embodiment of a fabrication process used to optimize the uniformity of critical dimensions in a repeated pattern on a substrate.

### DETAILED DESCRIPTION OF SEVERAL EMBODIMENTS

An apparatus and methods for providing critical dimensions through heat treatment is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

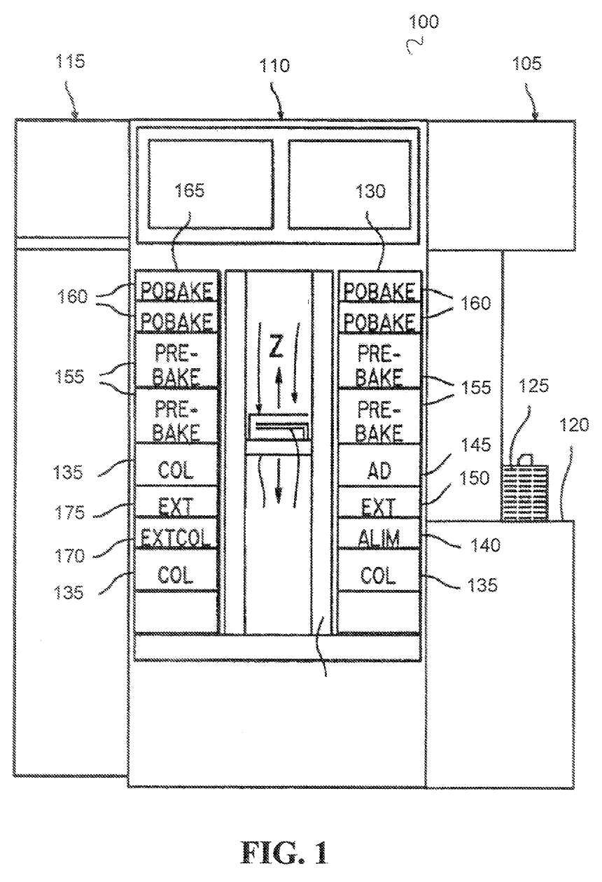

Beginning with the illustration in FIG. 1, one embodiment of a thermal or coating/developing system 100 has a load/unload section 105, a process section 110, and an interface section 11 5. In this embodiment, the load/unload section 105 has a cassette table 120 on which cassettes 125 each storing a plurality of semiconductor substrates are loaded and unloaded from the system 100. The process section 110 has various single substrate processing units for processing substrates sequentially one by one. The interface section 115 is interposed between the process section 110 and a light-exposure apparatus (not shown).

According to the embodiment illustrated in FIG. 1, a first process unit group 130 has a cooling unit (COL) 135, an alignment unit (ALIM) 140, an adhesion unit (AD) 145, an extension unit (EXT) 150, two prebaking units (PREBAKE) 155, and two postbaking units (POBAKE) 160, which are stacked sequentially from the bottom. Similarly, the second process unit group 165 has a cooling unit (COL) 135, an extension-cooling unit (EXTCOL) 170, an extension unit (EXT) 175, another cooling unit (COL) 135, two prebaking units (PREBAKE) 155 and two postbaking units (POBAKE) 160.

The cooling unit (COL) 135 and the extension cooling unit (EXTCOL) 170 may be operated at low processing temperatures and arranged at lower stages, and the prebaking unit (PREBAKE) 155, the postbaking unit (POBAKE) 160 and the adhesion unit (AD) 145 are operated at high temperatures and arranged at the upper stages. With this arrangement, thermal interference between units may be reduced. Alternatively, these units may have different arrangements. The prebaking unit (PREBAKE) 155, the postbaking unit (POBAKE) 160, and the adhesion unit (AD) 145 each comprise a heat treatment apparatus in which substrates are heated to temperatures above room temperature.

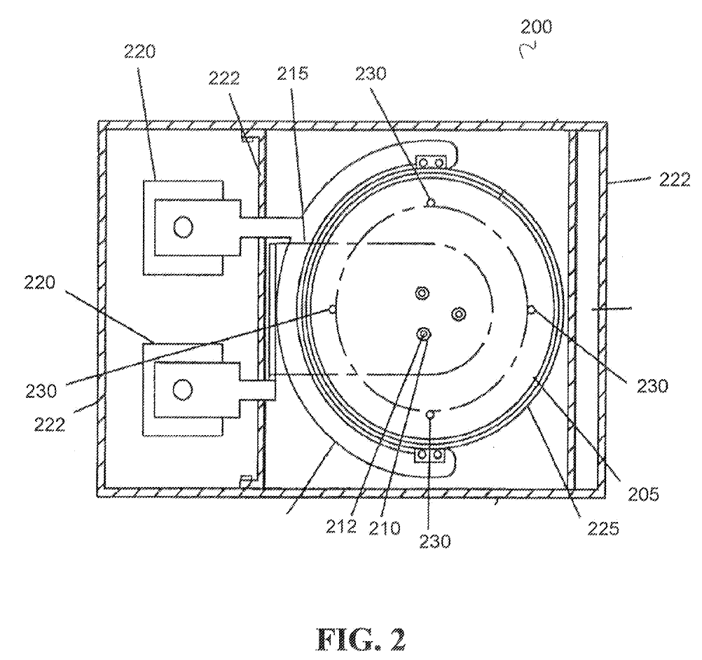

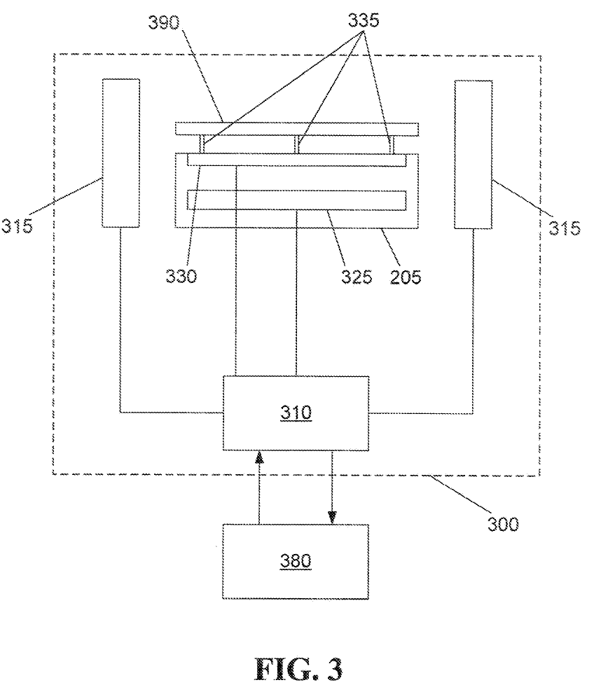

As illustrated in FIG. 2, each heat treatment apparatus includes a processing chamber 200, a heater such as a hotplate 205, and one or more resistance heating elements (not shown) embedded in the hotplate 205, though the embodiment is not so limited. In an alternate embodiment, the heating elements are located proximate to the hotplate 205. Any type of heater may be employed. The hotplate 205 has a plurality of through-holes 210 and a plurality of lift pins 212 inserted into the through-holes 210. The lift pins 212 are connected to and supported by an arm 215, which is further connected to and supported by a rod of a vertical cylinder 220. When the rod is actuated to protrude from the vertical cylinder 220, the lift pins 212 protrude from the hotplate 205, thereby lifting a substrate 390 (FIG. 3). In this embodiment, a ring-form shutter 225 is attached to the outer periphery of the hotplate 205.

A plurality of projections 230 may be located on an upper surface of the hotplate 205 for accurately positioning the substrate 390. In addition, a plurality of smaller projections (not shown) may be formed on the upper surface of the hotplate 205. When the substrate 390 is mounted on the hotplate 205, top portions of these smaller projections contacts the substrate 390, which produces a small gap between the substrate 390 and the hotplate 205, thereby preventing the lower surface of the substrate 390 from being strained and damaged.

The ring-form shutter 225 is positioned at a place lower than the hotplate 205 at non-operation time, whereas, at an operation time, the ring-form shutter 225 is lifted up to a position higher than the hotplate 205 and between the hotplate 205 and a cover (not shown). When the ring-form shutter 225 is lifted up, a cooling gas, such as nitrogen gas or air, is exhausted from air holes below the hotplate 205.

As illustrated in FIG. 3, a heat treatment apparatus 300 in accordance with an embodiment of the invention includes a controller 310, a cooling device 315, and a hotplate 205. Hotplate 205 comprises a heater 325, a sensor 330, and substrate support pins 335. A substrate 390 may be positioned on hotplate 205 using substrate support pins 335.

Hotplate 205 may have a circular shape and may comprise a number of segments. In addition, heater 325 may comprise a number of heating elements. For example, a heating element may be positioned within each segment of the hotplate 205. In an alternate embodiment, hotplate 205 may incorporate a cooling element and/or a combined heating/cooling element rather than a heating element.

Hotplate 205 may include a sensor 330, which may be a physical sensor and/or a virtual sensor. In addition, sensor 330 may comprise a number of sensor elements. For example, sensor 330 may be a temperature sensor located within each hotplate segment. In addition, sensor 330 may include at least one pressure sensor. Controller 310 is coupled to heater 325 and sensor 330. Various types of physical temperature sensors 330 may be used. For example, the sensor 330 can include a thermocouple, a temperature-indicating resistor, a radiation type temperature sensor, and the like. Other physical sensors 330 include contact-type sensors and non-contact sensors.

Heat treatment apparatus 300 may be coupled to a processing system controller 380 that is capable of transferring pattern parameter data, process history, and process flow information to and from the heat treatment apparatus 300. The pattern parameter data, process history and process flow information may be received and/or transmitted to another system by the processing system controller 380 through one or more ports. In one embodiment, a port is a wired communications pathway such as SEMI Equipment Communications Standard/Generic Equipment Model (SECS/GEM) interface. In another embodiment, the port is a wired Ethernet connection. Pattern parameter data may include optical digital profile (ODP) data, such as critical dimension (CD) data, profile data, or uniformity data, or optical data, such as refractive index (n) data or extinction coefficient (k) data. For example, CD data measurements collected by the metrology tool may include transistor gate widths, via or plug diameters, recessed line widths, or three-dimensional semiconductor bodies, though the embodiment is not so limited.

In one embodiment, the port may provide a communications pathway for receiving process history and pattern parameters of a first substrate, and for transmitting a process flow of a second substrate. Process history may comprise a collection of data such as process recipes, tool and chamber identifications, status, event reporting, in-line parametric data, or defectivity maps, or other information specific to the manufacturing steps used to fabricate a semiconductor device, liquid crystal display, or a microelectromechanical system. The process history can include information for all or any portion of the processes to which each substrate is subjected. A process flow may comprise process tool, process chamber, or recipe information for a semiconductor device, liquid crystal display, or a microelectromechanical system on a substrate to be processed.

A uniformity of critical dimensions of a substrate 390 extracted from the pattern parameter data may be used by the controller 310 to estimate a thermal response. In this embodiment, the controller 310 creates at least one intelligent setpoint for each of the plurality of hotplate segments, described herein. The incoming substrate 390 is then heated according to the intelligent setpoints to reduce critical dimension variation across the substrate 390, profile variation across the substrate 390, or uniformity variation across the substrate 390, or a combination of two or more thereof by controlling an actual temperature of each of the plurality of zones of the hotplate 205 using a corresponding one of the plurality of intelligent setpoints during processing.

Controller 310 may comprise a microprocessor, a memory (e.g., volatile and/or non-volatile memory), and a digital input/output port for transmitting and receiving data. A program stored in the memory may be used to control the aforementioned components of a heat treatment apparatus 300 according to a process recipe. Controller 310 may be configured to analyze the process data, to compare the process data with target process data, and to use the comparison to change a process and/or control the processing system components. Alternatively, the controller 310 may be configured to analyze the process data, to compare the process data with historical process data, and to use the comparison to predict and/or establish an endpoint.

In one embodiment, a cooling device 315 is provided around the hotplate 205. Air or nitrogen gas may be provided to one or more surfaces of the hotplate 205 by cooling device 315. The cooling device 315 can communicate with a gas supply source (not shown) at the upstream. Controller 310 can control the flow rate of gas flowing from the cooling device. In an alternate embodiment, heat treatment apparatus 300 may include a monitoring device (not shown) that, for example, perm its optical monitoring of the substrate 390.

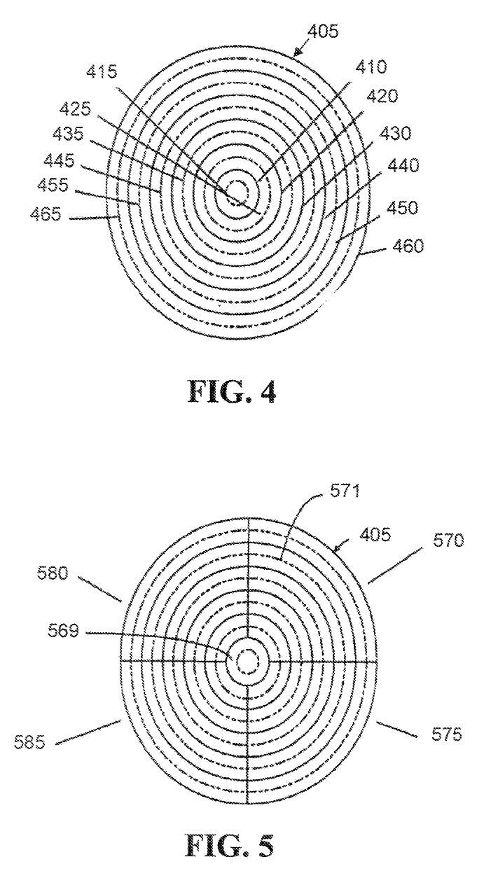

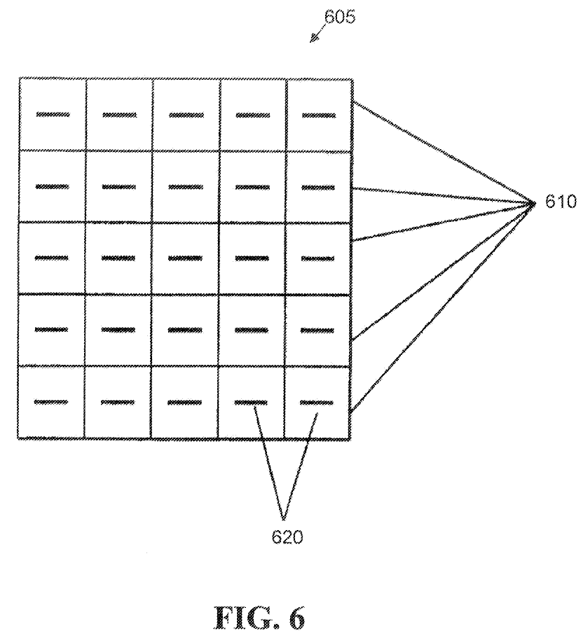

FIGS. 4 and 5 illustrate exemplary schematic views of hotplate 205 in accordance with alternate embodiments of the invention. In FIG. 4, a circular hotplate 405 has a circular segment 410 and a plurality of annular ring segments 420, 430, 440, 450, and 460. Hotplate 205 may include any number of segments, which may have any suitable geometrical arrangement and/or dimensions. For example, the annular ring segments may have different radial dimensions relative to the hotplate centerline. In the illustrated embodiment, each segment 420, 430, 440, 450, and 460 includes a corresponding one of a plurality of heating elements 415, 425, 435, 445, 455, and 465 each of which may be independently controlled.

With reference to FIG. 5, a circular hotplate 405 has a circular central segment 569 and a plurality of sectors 570, 575, 580, 585. Equal radial dimension segments are shown in FIG. 5, though this embodiment is not so limited. Circular hotplate 405 may include any number of sectors, which may have any suitable geometrical arrangement and/or dimensions. In the illustrated embodiment, each individual sector segment 570, 575, 580, 585 includes one of a plurality of heating elements 571 that may each be independently controlled.

FIG. 6 shows a schematic view of a rectangular hotplate 605, in accordance with an embodiment of the invention, having a plurality of, for example, twenty-five segments 610. Rectangular hotplate 605 may comprise a plurality of segments 610, and the segments 610 may be shaped differently. For example, rectangular shapes may be used. In the illustrated embodiment, each segment 610 of the rectangular hotplate 605 includes a heating element 620, and each heating element 620 may be independently controlled.

Alternately, any of hotplates 205, 405, and 605 may be constructed in the jacket form having at least one hollow and at least one recess. The substrate 390 (FIG. 3) may be heated by circulating a heat medium to the recesses, such as by inserting a heater or a heat pipe (not shown) into one or more recesses containing a liquid (heat medium). Alternatively, the hotplate 205 may be heated to a predetermined heat treatment temperature by allowing at least one hollow to be filled with vapor generated from a heat medium by application of heat thereto at one or more of the recesses.

The processing of substrates 390 may involve CD control, profile control, and/or uniformity control within each substrate and/or from substrate to substrate. For example, variations in CD measurements, profile measurements, and/or uniformity measurements may be caused by or compensated for by variations in thermal profile across substrate 390 zones and variations in thermal response from substrate-to-substrate and/or from lot-to-lot. An adaptive real-time CD (ARCD) control system may be used to compensate for these variations to produce consistent and reproducible critical dimensions within each substrate, substrate-to-substrate and/or from lot-to-lot.

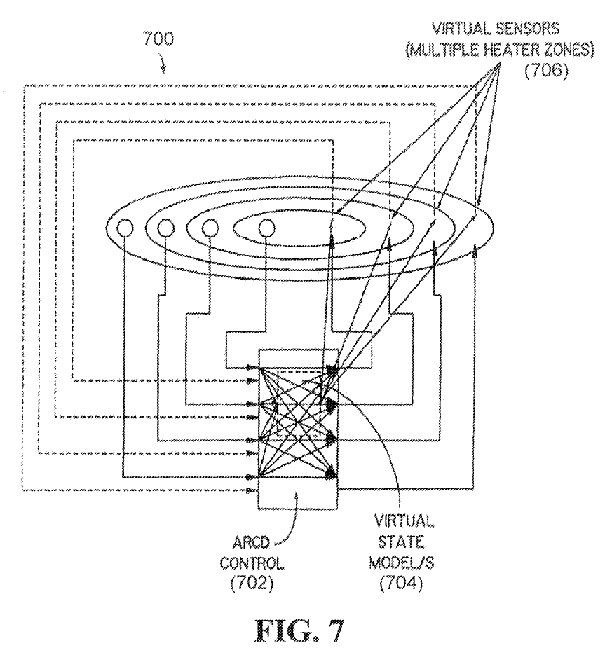

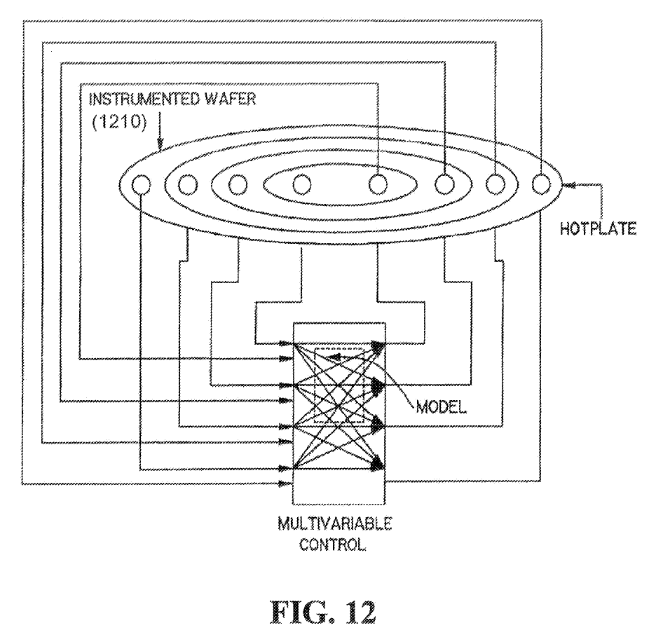

FIG. 7 illustrates a simplified block diagram of a thermal processing system 700 including multivariable control in accordance with an embodiment of the invention. An ARCD control system 702 includes virtual sensing with virtual sensors 706 that enables a user to “measure” substrate 390 temperatures in real-time and eliminates the need for instrumented substrates 1210 (FIG. 12) during production. The ARCD control system 702 provides multivariable real-time control that enables control of substrate 390 temperatures and intelligent setpoint control that enables desired CDs and profiles across the substrate 390 based on pattern parameters measured and communicated from a metrology system to the ARCD control system 702.

A static model (not shown) or a dynamic (e.g., virtual state) thermal model 704 characterizing the thermal response of the system may be created using instrumented substrates 1210 (FIG, 12) and may include the interaction between heater zones of the hotplate 205 and the substrate 390 (FIG. 3). Then, a thermal model 704 nay be used to create a multi-variable controller that controls the estimated substrate 390 temperatures in real-time. For example, a set of thermal models 704 may be created for the various substrate 390 types to be processed, which can account for expected critical dimension variation on a substrate 390 and can compensate in real-time for the variation using a thermal response. In one embodiment, an intelligent setpoint control (ISC) methodology may be established for the post-expo sure bake (PEB) process. In another embodiment, the ISC methodology may be established for a hard-bake process.

In a static embodiment, a static model may be employed to initially set up the heaters and then run the processes in a non-dynamic model with no real time feedback.

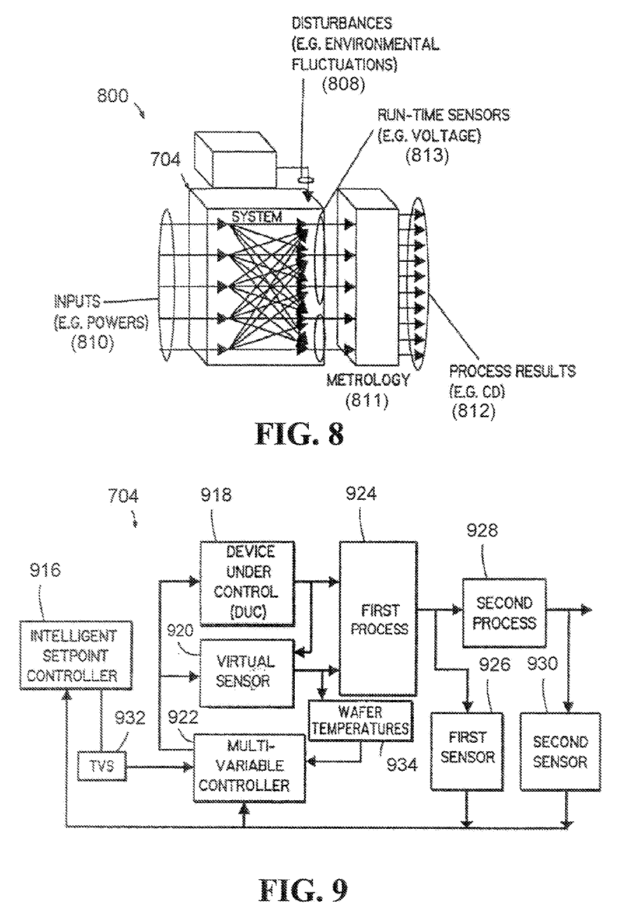

With reference to FIG. 8, the ARCD control system 702 may be described by a multivariable multi-input/multi-output (MIMO) system 800, in accordance with one embodiment of the invention, having several input and output channels. In general, real-life systems, such as the illustrated MIMO system 800, are dynamically complex and non-linear. Their transient responses are important for performance and are often difficult to determine. The outputs of the system or the process results 812 may be affected by unknown disturbances 808, such as environmental fluctuations. In general, for MIMO systems 800, each input (e.g., heater power) 810 can affect multiple outputs 812. Metrology 811, constituting the pattern parameter data in one embodiment of the invention, is processed with data collected by run-time sensors 813 to provide the desired process results 812.

With reference to FIG. 9, the thermal model 704 includes an intelligent setpoint controller 916, a device under control (DUC) 918, a virtual sensor 920, and a multivariable controller 922. In one embodiment, the device under control (DUC) 918 may be a thermal or coating/developing system 100 including a hotplate 205. The thermal model 704 may perform a first process 924 monitored by a first sensor 926. For example, the first process 924 may be a post-exposure bake process and the first sensor 926 can provide output data and/or error data from the first process 924. The thermal model 704 may also perform a second process 928 monitored by a second sensor 930. For example, a second process 928 may be a develop process and the second sensor 930 can provide output data and/or error data from the second process 928. In one embodiment, the second sensor 930 may be a metrology system that measures a plurality of pattern parameters on a first substrate to create a thermal model 704 for a second substrate.

The intelligent setpoint controller 916 can calculate and provide time varying setpoints (TVS) 932 to the multivariable controller 922. The intelligent setpoint controller 916 and the multivariable controller 922 can comprise hardware and/or software components. The virtual sensor 920 may provide substrate 390 temperatures and/or hotplate temperatures 934 to the multivariable controller 922.

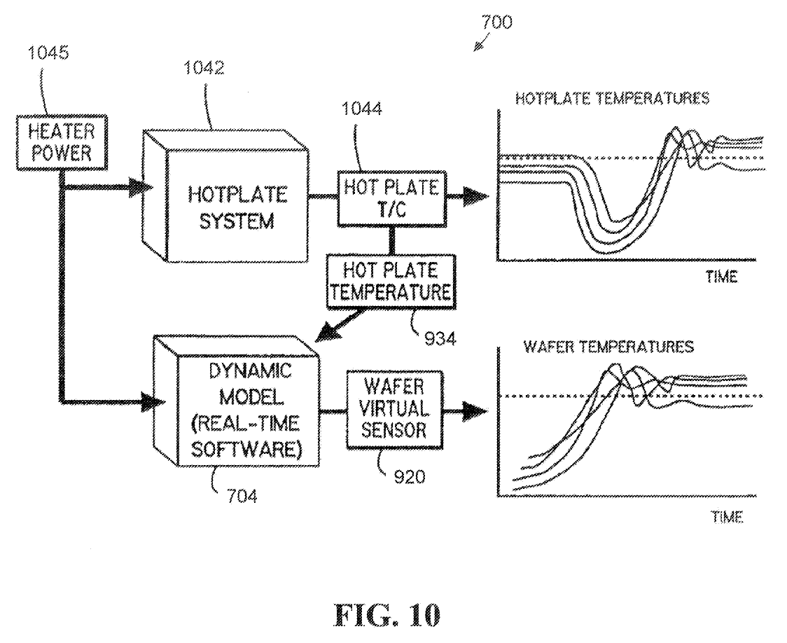

FIG. 10 illustrates a schematic representation of a thermal processing system 700 including an embodiment of the virtual sensor 920 for measuring the temperature of a substrate 390 heated by a hotplate system 1042. The virtual sensor 920 allows the substrate 390 temperatures to be “measured” and controlled using hotplate temperatures 934, which are measured using a hot plate thermocouple 1044, by varying the applied power 1045 to the heater. The thermal model 704 is constructed detailing the dynamic interaction between the hotplate system 1042 and the substrate 390 (FIG. 3) including variations in the substrate's composition and flatness (i.e., bow). Virtual sensing provides a method for obtaining substrate 390 temperatures in real-time.

Virtual sensors 920 eliminate the need for instrumented substrate(s) 1210 during production and provide an offset for relatively fixed input variables that may otherwise affect expected outputs such as hotplate temperatures 934. For example, a thermal model 704 and virtual sensors 920 may be created once for the hotplate system 1042., the thermal model 704 may be tuned with a few substrates 390 during initial qualification of the thermal or coating/developing system 100.

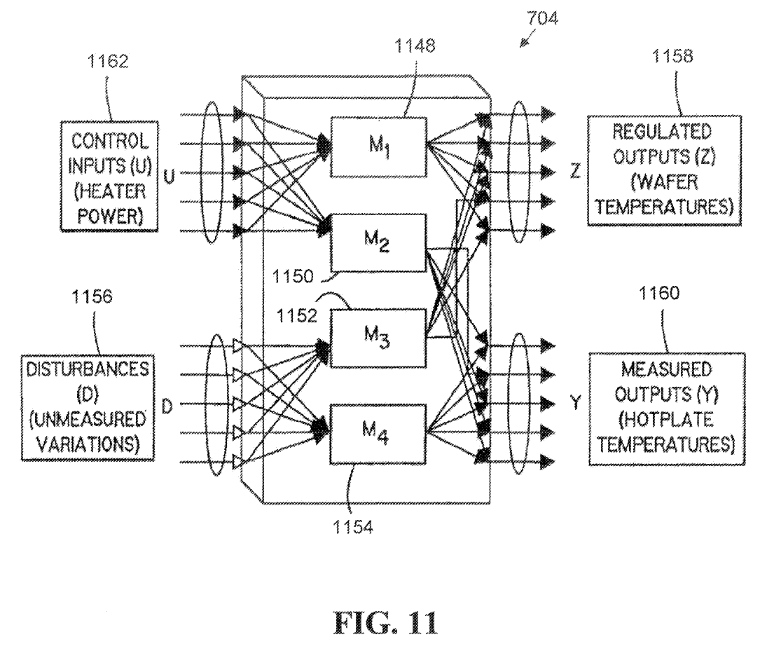

FIG. 11 illustrates a schematic representation of an embodiment of the thermal model 704 characterizing the thermal response of a thermal processing system 700 in accordance with an embodiment of the invention. In the illustrated embodiment, four nodes or model components (M₁, M₂, M₃, and M₄) 1148. 1150, 1152, 1154 are shown. However, in alternative embodiments of the invention, a different number of model components may be used, and the model components may be arranged with a different architecture.

In, addition, the thermal model 704 receives control inputs 1162 (U), such as heater power, and disturbance inputs (D) 1156, such as unmeasured variations, and determines regulated outputs (Z) 1158, such as substrate 390 temperatures, and measured outputs (Y) 1160, such as hotplate temperatures. The model structure may be expressed as Z=M₁U+M₃D and Y=M₂U+M₄D. Alternately, a different expression for the model structure may be used.

The thermal model 704 tracks the “state” of the system, and relates the inputs 1162 to regulated outputs 1158 and measured outputs 1160 in real-time. For example, U, Y may be measured, and by using the thermal model 704, D may be estimated using Y=M₂U+M₄Dₑₛₜ and Z may be estimated using Zₑₛₜ=M₁U+M₃Dₑₛₜ.

Pattern parameter data is incorporated into the thermal model 704 when creating the thermal model 704 to compensate for variability that is expected to be added by downstream processing. The compensation provided by the thermal model 704 is designed to counteract the net variability added by one or more subsequent processes. Multivariable controllers (not shown) may be used to calculate the zone-to-zone interaction during the ramp and stabilization modes. An intelligent setpoint controller of thermal model 704 may be used to parameterize the nominal setpoints, create intelligent setpoints using an efficient optimization method and process data, and select appropriate models and setpoints during run-time.

One step in an intelligent setpoint control (ISC) methodology to construct an intelligent setpoint controller 916 (FIG. 9) is to create a thermal model 704 that describes the dynamic behavior of a processing system, such as a thermal processing system 700. Such thermal models 704 may be used to design a multivariable controller and then for creating the sensitivity matrix and the intelligent setpoints.

Several approaches are available for creating thermal models 704 including, but not limited to, first principles models based on heat transfer, gas flow, and reaction kinetics, and on-line models created with real-time data collected from a processing system, such as a thermal processing system 700.

In a first principles dynamic thermal model for characterizing the intelligent set point controller 916 (FIG. 9), the substrate 390 and hotplate 205 can comprise several annular ring segments 420, and the heat transfer between the substrate 390 and hotplate 205 as well as to the ambient environment may be modeled for each segment. For example, the substrate 390 may be partitioned into n such concentric segments, and the following mathematical relationship shows the thermal response of the kₜₕ such segment:

$$ρ {C}_{p} {V}_{k} \frac{d {T}_{k}}{d t} = - \frac{{k}_{o} {A}_{k}}{{δ}_{k}} ( {T}_{k} - {T}_{p} ) - {hA}_{k} ( {T}_{k} - {T}_{a} ) - \frac{{k}_{w} {C}_{k}}{{d}_{k}} ( {T}_{k} - {T}_{k - 1} ) - \frac{{k}_{w} {C}_{k + 1}}{{d}_{k + 1}} ( {T}_{k} - {T}_{k + 1} )$$

where the parameters are:

k_{w} Substrate thermal conductivity

Vₖ Volume of k^{th} segment

Aₖ Area of k^{th} segment

dₖ Distance between the k^{th} and the (k-1)^{th} segment

Cₖ Contact area between the k^{th} and the (k-1)^{th} segment

δₖ Air gap distance between the k^{th} segment and the hotplate

ρ Substrate density

Cₚ Substrate heat capacity

Tₐ Ambient temperature

h Heat transfer coefficient to ambient

kₐ Air gap thermal conductivity

Tₚ Plate temperature

Tₖ Substrate temperature

The parameter δₖ depends on the location of the element and may be specified according to the substrate 390 shape. Similarly, the hotplate 205 is also partitioned into concentric segments and described by a similar mathematical relationship.

In one embodiment for modeling the ISC, thermocouples are assumed to be co-located with the heater 325 in the hotplate 205 and any dynamics (e.g., time constants for thermocouple response) associated with the thermocouples are not included in the model. In effect, the model assumes instantaneous temperature measurements. Alternately, thermocouples are not co-located with the heater in the hotplate 205, and/or any dynamics associated with the thermocouples may be included in the model. Energy may be transferred between the plate and the substrate 390 via an air gap. The air gap for each element depends on the substrate 390 radius of curvature and may be included in the model.

The first principles dynamic thermal model defines a set of n differential equations, which may be expressed in compact form by the equation \dot{T}=f(T,Tₚ,Tₐ). Here, T is a vector that represents the n substrate 390 element temperatures. Simulations using these differential equations may be used to induce variations in thermal response, and hence thermal dose, across the substrate 390. In an alterative embodiment, the ISC may be described by an on-line thermal model. For example, one method to obtain dynamic thermal models can use real-time data collection. In such real-time models, dynamic thermal models are created based on real-time data collected from a hotplate 205, for example.

One method for collecting substrate 390 temperatures is using an instrumented substrate 1210 as shown in FIG. 12. In this method of substrate temperature collection, setpoint trajectories for the sensor time constants may be obtained. The setpoint trajectory is selected to exercise the thermal behavior of the systems The entire response of the system is recorded in a log file, and the log file can provide synchronous time-trajectories sensor setpoints, sensor time constants, heater power, and substrate temperatures. The measured substrate temperatures are utilized to verify the accuracy of the ISC model. Alternately, optical measurements of substrate 390 temperatures may also be used.

The on-line thermal model may define a dynamic system with heater powers as inputs and the various temperatures, substrate 390 as well as sensor, as output, and the model may be represented by a set of linear differential equations: \dot{T}=f(T,P) where the function f(T,P) is linear. To obtain the closed-loop system, a known controller may be applied around this set of equations to obtain the closed-loop response. This method can provide a high fidelity model of the substrate 390 temperature thermal response. The on-line thermal model may, alternatively, be described by multiple linear models that describe the thermal behavior across a broad temperature range. For this purpose, the substrate 390 temperatures may be measured at multiple temperature ranges, and a model may be created that switches from one temperature range to the next as needed.

Pattern parameter data from a first substrate may be incorporated into either the first principles model or the on-line thermal model, which are described above, for establishing intelligent setpoint control of a second substrate. In addition. substrate bow data may be incorporated into the first principles model. For the first principles model, the gap between the substrate 390 and hotplate 205 for each substrate 390 element may be directly modeled. For example, if r_{c} is defined as the radius of curvature of the substrate 390, then, the substrate 390 subtends an angle

$$θ = \frac{{w}_{d}}{{r}_{c}} .$$

Based on this angle, the air gap at a given radial location may be computed as:

$${δ}_{k} = {r}_{c} ( 1 - cos \frac{θ}{k} ) .$$

During model development, a first principles model including pattern parameter data from a first substrate and bowing data from a second substrate bowing may be implemented numerically on a suitable microprocessor in a suitable software simulation application, such as Matlab. The software application resides on a suitable electronic computer or microprocessor, which is operated so as to perform the physical performance approximation. However, other numerical methods are contemplated by the present invention.

A method for providing critical dimensions of a pattern on a substrate is illustrated in F 13. In element 1300, a plurality of pattern parameters on a first substrate are measured using a metrology system. In one embodiment, a metrology tool such as a spectroscopic ellipsometry tool, an atomic force microscope, or a scanning electron microscope is used to measure the width of a gate of a transistor on a first area of the substrate 390. This measurement is a first pattern parameter collected by the metrology tool. The metrology tool may also measure the width of a gate of a transistor from a second area of the substrate 390. This measurement is a second pattern parameter collected by the metrology tool, resulting in a plurality of pattern parameters. Additional pattern parameter measurements may be collected to provide a uniformity map of pattern features on a substrate. In another embodiment, measurements collected by the metrology tool may include via or plug diameters, recessed line widths, or three-dimensional semiconductor bodies, though the embodiment is not so limited.

In an alternate embodiment, a metrology tool is used to collect pattern parameters in a microelectromechanical system (MEMS) manufacturing environment. As an example, a metrology tool measures the width of a structure, such as an actuator or beam, on a first area of a substrate. This measurement is a first pattern parameter collected by the metrology tool. The metrology tool also measures the width of a structure on a second area of the substrate. This measurement is the second pattern parameter collected by the metrology tool, resulting in a plurality of pattern parameters. Additional pattern parameter measurements, may also be collected to provide a uniformity map of pattern features on a substrate.

The plurality of pattern parameters measured by the metrology tool is received, as described in element 1310. In one embodiment, the plurality of pattern parameters is transmitted from the metrology tool and received by a lithography tool, comprising a hotplate 205, through a wired connection. In another embodiment, the plurality of pattern parameters is transmitted from the metrology tool and received by the lithography tool, comprising a hotplate 205, through a low-power wireless connection. The plurality of pattern parameters may be communicated point-to-point or through an intermediate module, such as a factory automation system. One part of a factory automation system is an information automation system. An information automation system is associated with the execution of process steps by a manufacturing execution system, communication connections, and monitoring of the process equipment for recipe and process management, and material identification and tracking.

A process history for the first substrate is received from an information automation system, as shown in element 1320. The process history is a collection of data, gathered by the information automation system, comprising data such as process recipes, tool and chamber identifications, status, event reporting, in-line parametric data, defectivity maps, as well as other information specific to the manufacturing steps used to fabricate the semiconductor device, LCD, or MEMS. In one embodiment, the process history comprises tool, chamber, recipe, and event time information for the first substrate. The process history can include coating, development and etching steps for the first substrate.

A thermal model is created by the thermal or coating/developing system 100 based at least in-part on the plurality of pattern parameters of the first substrate, as shown in element 1330. The thermal model may define a dynamic system with heater powers as inputs and various temperatures, substrate 390 as well as sensor, as outputs. A plurality of intelligent setpoints are established as shown in element 1340, using the thermal model, wherein each of the plurality of intelligent setpoints is associated with a corresponding one of a plurality of zones of a hotplate 205. The plurality of zones of a hotplate 205 may be a series of annular ring segments 420, a group of sectors of a circle, or a grid of rectangles of a rectangular hotplate 205. The intelligent setpoints may be static or dynamic in reference to a processing of a second substrate. The intelligent setpoints are derived to compensate for a substrate 390 profile, comprising substrate 390 topography information, substrate 390 layer information, or uniformity data gathered from a single substrate 390 or from a plurality of substrates where a repeated pattern of non-uniformity is detected.

As described in element 1350, a second substrate is positioned proximate to the hotplate 205 for thermal processing. In one embodiment, the second substrate is positioned above the hotplate 205, separated from the hotplate 205 by a thin film of gas such as air, and heated by convective and radiation heat transfer. In another embodiment, the second substrate is positioned directly on the hotplate 205, allowing the second substrate to be heated by conducting heat directly from the plurality of zones of the hotplate 205 to the second substrate. An actual temperature of each of the plurality of zones of the hotplate 205 is controlled using a corresponding one of the plurality of intelligent setpoints, as described in element 1360. In one embodiment, the actual temperature of a first zone of the hotplate 205 is higher th,an one or more remaining zones of the hotplate 205 to control critical dimension variation across the second substrate, profile variation across the second substrate, or uniformity variation across the second substrate, or a combination of two or more thereof, based on a plurality of pattern parameters measured on a first substrate. Such control can result in reduced variations. In another embodiment, the actual temperature of a plurality of zones of the hotplate 205 is higher than one or more remaining zones of the hotplate 205.

A process flow is established, as described in element 1370, for the second substrate based at least in part on the process history of the first substrate. In one embodiment, the process flow for the second substrate comprising tool, chamber, and recipe information is matched to the process history of the first substrate. In this embodiment, the established process flow pre-determines a process path for the second substrate so that the second substrate is processed in the same tools, chambers, and recipes as the process path of the first substrate. As a result, the variation induced by the process path is pre-compensated by the thermal process of the thermal or coating/developing system 100, thereby controlling critical dimension variation across the second substrate, profile variation across the second substrate, or uniformity variation across the second substrate, or a combination of two or more thereof. Such control can result in reduced variations.

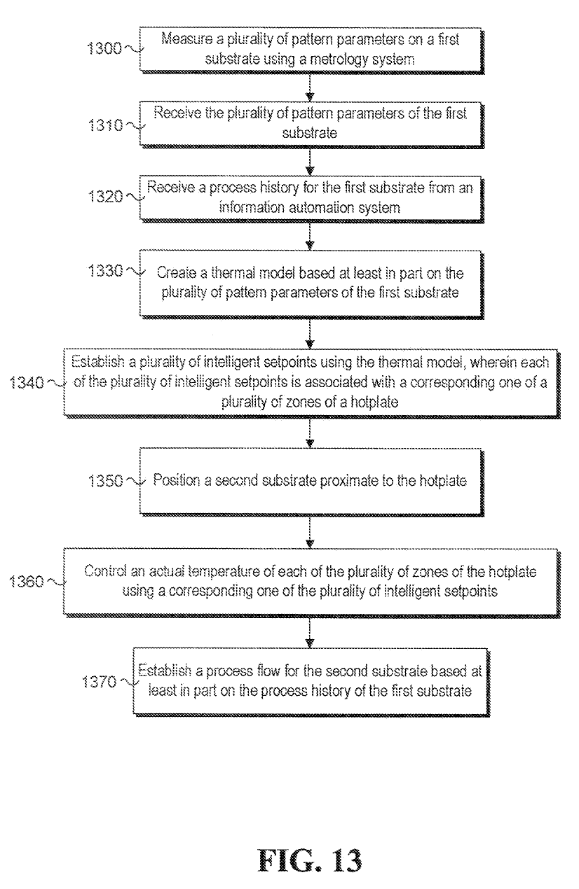

The process described above and illustrated in FIG. 13 can be repeated and/or extended. For example, patterns on a substrate may be created and elements 1300 to 1340 in FIG. 13 may be performed in one, two, three, or more iterative cycles of running one or more test (setup) substrates to refine the set points until the successive improvements of the parameters stabilize. Manufacturing runs of elements 1350-1370 in FIG. 13 can be in a non-dynamic mode after the initial setup is run dynamically. Of course, as described above, both the setup and manufacturing can be run in dynamic mode. Alternatively, initial setup would not be optimized and manufacturing would be run in a dynamic compensation mode.

A plurality of embodiments of a method and apparatus for providing critical dimensions of a pattern on a substrate has been described. The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first second, etc. that are used for descriptive purposes only and are not to be construed as limiting. For example, terms designating relative vertical position refer to a situation where a device side (or active surface) of a substrate or integrated circuit is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations.

Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A method of providing critical dimensions, comprising:
measuring a plurality of pattern parameters on a first substrate using a metrology system;
receiving the plurality of pattern parameters of the first substrate;
receiving a process history for the first substrate from an information automation system;
creating a thermal model based at least in part on the plurality of pattern Parameters of the first substrate;
establishing a plurality of intelligent setpoints using the thermal model, wherein each of the plurality of intelligent setpoints is associated with a corresponding one of a plurality of zones of a heater;
positioning a second substrate proximate to the heater;
controlling an actual temperature of each of the plurality of zones of the heater using a corresponding one of the plurality of intelligent setpoints during processing to control critical dimension variation across the second substrate, profile variation across the second substrate, or uniformity variation across the second substrate, or a combination of two or more thereof; and
establishing a process flow for the second substrate based at least in part on the process history of the first substrate.

2. The method of claim 1, wherein the thermal model is a dynamic thermal model.

3. The method of claim 1, wherein the pattern parameters are critical dimensions of a pattern on the first substrate.

4. The method of claim 3, wherein the pattern on the first substrate comprises circuit features.

5. The method of claim 1, wherein the process history includes at least one of a process tool, process chamber, and process recipe information.

6. The method of claim 5, wherein the process flow for the second substrate matches the process tool, process chamber, and process recipe information of the process history of the first substrate.

7. The method of claim 1, further including:
modeling a thermal interaction between the zones of the heater; and
incorporating the model of the thermal interaction into the thermal model of the system.

8. The method of claim 1, further including:
creating a virtual sensor for estimating a temperature for the substrate; and
incorporating the virtual sensor into the thermal model of the system.

9. The method of claim 1, further including:
modeling a thermal interaction between the heater and an ambient environment; and
incorporating the model for the thermal interaction into the thermal model of the system.

10. The method of claim 1, wherein the controlling is to reduce the critical dimension variation, the profile variation or the uniformity variation.

11. A system, comprising:
a substrate handling system;
a heater comprising a plurality of heat treatment zones;
an interface, for receiving process history and pattern parameters of a first substrate, and for transmitting a process flow of a second substrate; and
a controller for creating a thermal model and establishing a plurality of intelligent setpoints, based at least in part on the plurality of pattern parameters, and for controlling an actual temperature of each of the plurality of zones of the heater based at least in pad on the plurality of intelligent setpoints.

12. The system of claim 11, wherein the interface receives the process history from an information automation system and transmits a process flow of a second substrate to a information automation system.

13. The system of claim 11, wherein the interface comprises a plurality of communication ports.

14. The system of claim 11, wherein the heater is a hotplate,

15. The method of claim 1, wherein the process history is obtained for coating, developing or etching or any combination of two or more thereof.

16. The method of claim 1, wherein the measuring, the parameter receiving, the process history receiving, the creating and the establishing are repeated at least once.

17. The method of claim 2, wherein the process flow establishing is static.

18. The system of claim 11, wherein the process history is obtained for coating, developing or etching or any combination of two or more thereof.

19. The system of claim 11, wherein the controller repeats the creating and the controlling at least once during setup.

20. The system of claim 11, wherein the controller performs the creating dynamically during setup and statically during manufacturing.
